(19) United States
(12) Patent Application Publication
(10) Pub. No.: US 2026/0087365 A1
(43) Pub. Date: Mar. 26, 2026

(54) SYSTEMS AND METHODS FOR EVALUATING AND IMPROVING CONTEXT FAITHFULNESS IN A NEURAL NETWORK LANGUAGE MODEL

(71) Applicant: Salesforce, Inc., San Francisco, CA (US)

(72) Inventors: Yifei Ming, Palo Alto, CA (US); Senthil Purushwalkam Shiva Prakash, Palo Alto, CA (US); Shafiq Rayhan Joty, San Jose, CA (US)

(21) Appl. No.: 19/041,840

(22) Filed: Jan. 30, 2025

Related U.S. Application Data
(60) Provisional application No. 63/697,909, filed on Sep. 23, 2024.

(51) Int. Cl. G06N 3/094; G06N 3/0475

(52) U.S. Cl. CPC G06N 3/094; G06N 3/0475

(57) ABSTRACT

Embodiments described herein provide a framework for evaluating and training neural network-based language models. Under the framework, training datasets that can be used to evaluate and train the models are generated by modifying sample training datasets such that the training datasets may include unanswerable context, inconsistent context, and/or counterfactual context. A portion of the training datasets is used to evaluate a model's faithfulness quality. Based on the evaluation, a subset of the training datasets can be selected and used to train the model, which improves the faithfulness quality of the model.

### CROSS REFERENCE(S)

The instant application is a nonprovisional of and claim priority under 35 U.S.C. 119 to U.S. provisional application No. 63/697,909, filed Sep. 23, 2024, which is hereby expressly incorporated by reference herein in its entirety.

### TECHNICAL FIELD

The embodiments relate generally to machine learning systems for evaluating and improving faithfulness to context in large language models, and more specifically to generation of training data and training large language models to improve their context faithfulness performance.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

The rapid development of large language models (LLMs) has significantly advanced natural language understanding and generation tasks, enabling systems to produce fluent and coherent responses across a variety of applications. However, the issue of faithfulness hallucination-generating ungrounded or unsupported content by an LLM-remains significant. Faithfulness is particularly critical in high-stakes domains and personalized applications, such as healthcare and law, where inaccurate or unsupported responses undermine users' trust and may lead to serious consequences.

One of the key difficulties in addressing faithfulness hallucination arises from the complexity of retrieval-augmented systems (also referred to as “retrieval-augmented generation,” or simply “RAG”), where retrieved documents come from sources with varying levels of credibility. The retrieved content can have multiple paragraphs with relevant information but missing key details or contain conflicting evidence. Moreover, solutions aimed at hallucination detection do not guarantee that hallucinations will be avoided during generation, particularly in multi-paragraph retrieval scenarios. Therefore, there is a need for systems and methods for evaluating and improving faithfulness in LLMs.

### BRIEF DESCRIPTION OF THE DRAWINGS

FIG. 1 is a simplified diagram illustrating an environment within which an artificial intelligence model is implemented according to some embodiments.

FIG. 2 illustrates example tasks that likely lead to faithfulness hallucinations in large language models according to some embodiments.

FIG. 3 illustrates a framework for evaluating and training a large language model for improving a faithfulness quality of the large language model according to some embodiments.

FIG. 4 is a simplified diagram illustrating a computing device implementing the framework according to some embodiments.

FIG. 5 is a simplified diagram illustrating a neural network structure, according to some embodiments.

FIG. 6 is a simplified block diagram of a networked system suitable for implementing a large language model and other embodiments described herein.

FIG. 7 is an example logic flow diagram illustrating a method of generating training data for training a large language model based on the framework according to some embodiments.

FIGS. 8-15 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

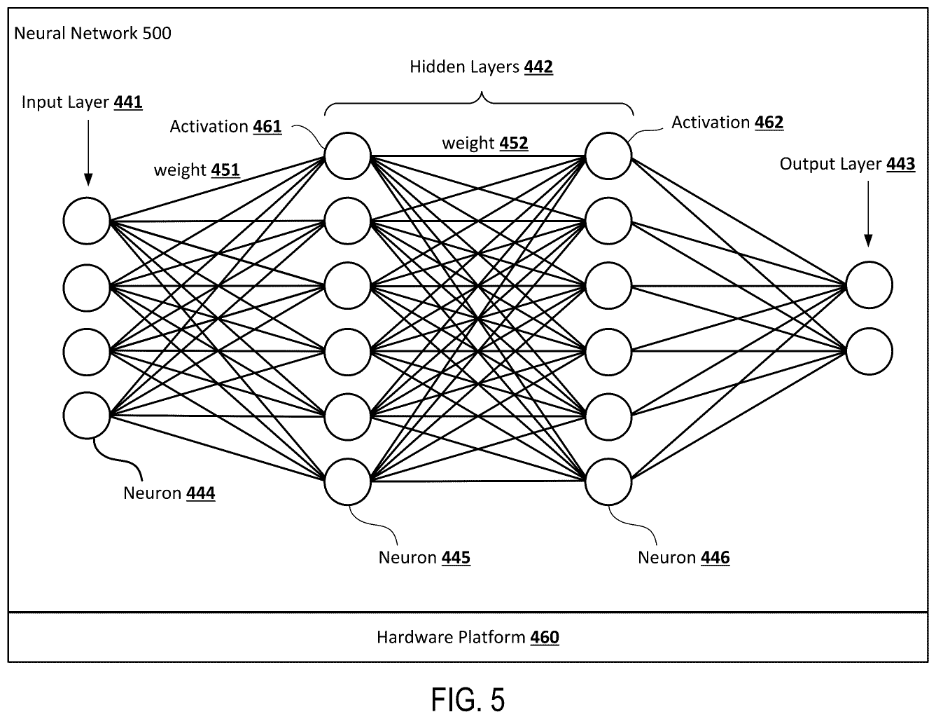

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pre-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

The rapid development of LLMs has significantly advanced natural language understanding and generation tasks, enabling computer systems to produce fluent and coherent responses across a variety of applications. The capabilities of these models have been further enhanced by integrating external information from the Internet or knowledge sources using a Retrieval-Augmented Generation (RAG) approach. In this paradigm, additional information that is relevant to a task is retrieved, encoded, and provided to the LLM as a context, such that the LLM may generate outputs for the task using the context. While RAG enhances the ability of LLMs in generating accurate outputs by integrating additional relevant context for the LLMs to complete the tasks, faithfulness hallucination in LLMs remains a challenge.

Faithfulness hallucination occurs when an LLM generates a response that is unsupported by (e.g., inconsistent with, not derivable from, etc.) the provided context. A response is unsupported by the provided context when the provided context does not include any information that can be used to derive and/or infer the response and/or when the provided context includes information that is in conflict with the response. Maintaining faithfulness to the context is especially important for various applications of LLMs, and can be critical in high-stakes domains such as healthcare and law, where inaccurate or ungrounded responses can erode user trust and lead to severe consequences.

One of the key challenges in addressing faithfulness hallucination in RAG-based LLM systems stems from the retrieval process, where the wealth of documents that can be retrieved for a task varies in credibility. This complexity is further compounded when long retrieved content includes multiple relevant paragraphs that omit key details, present conflicting evidence, or propagate counterfactual claims.

For example, an LLM may generate a response that is unsupported by the provided context when the context (e.g., the documents retrieved for the question) includes information that is generally relevant to the question but does not include information that specifically points to the response. In this example, the LLM should indicate that it has insufficient information to provide a response, instead of providing an unsupported response. In another example, an LLM may generate a response to a question using information from a first portion of the provided context, but the response is in conflict with a second portion of the provided context. Instead, the LLM should indicate that multiple conflicting answers are available for the question, and it is unsure which one is correct. In yet another example, an LLM may generate a response to a question based on a widely known fact that has been learned by the LLM (e.g., from previous training of the LLM), but the response is in conflict with information provided in the context. In this example, the LLM should provide a response that is supported by the context, even if it conflicts with the learned fact from previous training.

In view of the need for improving the faithfulness of responses generated by LLMs, embodiments described herein provide a framework for generating training datasets that are specifically designed to address various scenarios where faithfulness hallucination in LLMs would likely occur, and evaluate and/or train the LLMs to avoid generating answers that are unsupported by the provided context. It has been contemplated that tasks that involve unanswerable questions based on the provided context (also referred to as “unanswerable context”), context that includes conflicting answers to the questions (also referred to as “conflicting context”), and context that includes answers that are in conflict with widely accepted facts (also referred to as “counterfactual context”) have a higher likelihood for an LLM to generate unsupported responses than other scenarios. As such, in some embodiments, the framework can be used to generate and validate training datasets related to these tasks, and to evaluate and/or train an LLM using the training datasets.

In some embodiments, the training datasets can be generated based on modifying existing sample training datasets that are not specific to target faithfulness hallucination and usable to train the LLMs. Each of the sample training datasets may include a question, a ground truth answer, and optionally a context. Using the framework disclosed herein, a new task may be generated based on an existing training dataset (also referred to as “sample training dataset”), for example, by modifying the sample training dataset. In some embodiments, the same sample training dataset can be modified to generate different tasks corresponding to the different scenarios.

For example, the sample training dataset may be used to generate a task that involves unanswerable context. To generate the task that involves unanswerable context, the context included in the sample training dataset may be modified to remove any data that support the ground truth answer. The task (e.g., the training dataset) may then include the modified context, the question, and a response that indicates that no answer can be provided based on the context. In some embodiments, the task also includes a specific instruction, instructing LLM that the response should be “unknown” if no information available in the context supports any answer to the question.

The sample training dataset may also be used to generate a task that involves conflicting context. To generate the task that involves conflicting context, the context included in the sample training dataset may be modified to incorporate additional information that conflicts with the ground truth answer. The task (e.g., the training dataset) may then include the modified context, the question, and a response that includes the multiple available answers based on the modified context and indicates that it is unsure which of the answers are correct. In some embodiments, the task also includes a specific instruction, instructing LLM that if there is conflicting information or multiple answers in the context, the response should indicate the multiple answers and is unsure which answer is correct.

The sample training dataset may also be used to generate a task that involves answering a question using a context that conflicts with a widely accepted fact (e.g., counterfactual context). To generate the task that involves answering a question using a context that conflicts with a widely accepted fact, a new fictitious context may be generated that supports a fictitious answer, where the fictitious answer conflicts with a widely accepted fact. The fictitious answer is also used to substitute the ground truth answer. The task (e.g., the training dataset) may then include the newly generated context, the question, and a response that indicates the fictitious answer. Since a new context is generated for this task, sample training datasets that do not include existing contexts can be used to generate the task that involves answering a question using a context that conflicts with a widely accepted fact.

The same process can be applied to other sample training datasets such that a large number of training datasets are generated for training the LLM. The training datasets may then be assessed. For example, each training dataset may be assessed by determining (i) whether the response included in the training dataset is supported by the context and (ii) whether any alternative answer not included in the response is also supported by the context. A training dataset is validated only if the response included in the training dataset is supported by the context and no other alternative answer is supported by the context. In some embodiments, only the validated training dataset is used to evaluate and/or train the LLM. The LLM may then be evaluated and trained using the training datasets. By training the LLM using the training datasets generated using the framework disclosed herein, the faithfulness of the responses generated by the LLM can be improved.

The training datasets generated under the framework as disclosed herein can also be used to evaluate the performance of the LLM. For example, the context and the question included in a training dataset may be provided to the LLM as inputs. The performance of the LLM may be evaluated based on comparing the output generated by the LLM and the response included in the training dataset. In some embodiments, in order to provide more efficient training of the LLM, the LLM is evaluated based on a portion of the training datasets to determine one or more weaknesses of the LLM (e.g., whether the LLM performs worse on tasks related to unanswerable context or tasks related to conflicting context, etc.). Training datasets that target the one or more weaknesses of the LLM may be selected to train the LLM to improve the LLM's performance in performing those tasks.

Embodiments described herein provide a number of benefits. For example, time, memory, computations, and power consumption of an LLM may be reduced by providing results with higher faithfulness. The methods may be applied to existing LLMs, and adapt to different LLMs. Improved faithfulness may enable or improve performance in different tasks such as retrieval augmented generation (RAG), customer service chat bots, code generation, autonomous LLM agents, automated question answering, and other tasks that may benefit from the use of an LLM. Therefore, with improved performance including faithfulness on LLM, neural network technology in language generation is improved.

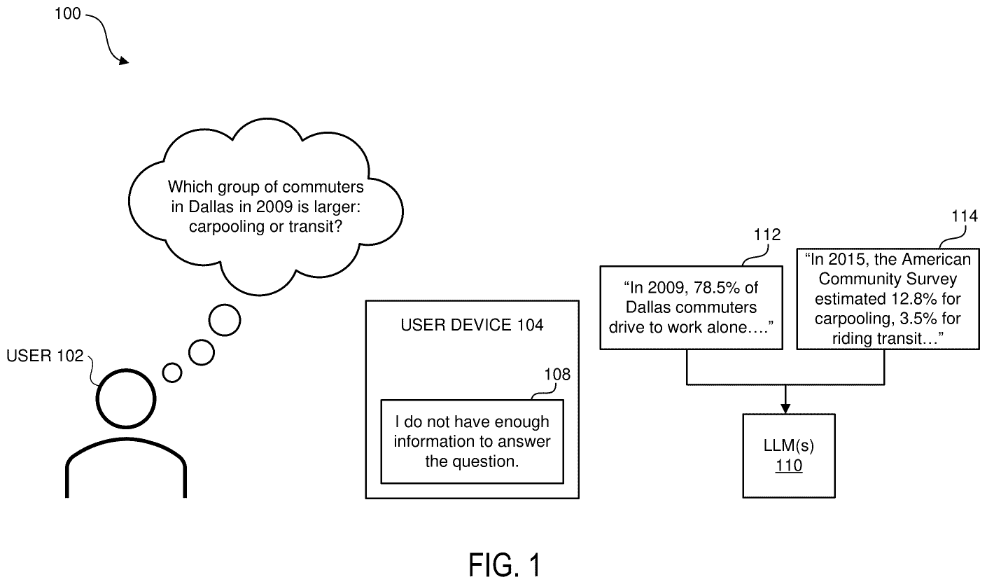

FIG. 1 shows an application 100 of an LLM based AI agent, according to embodiments of the present disclosure. A user 102 may utter a query 106 in natural language. In response, a user device 104 may output/display an answer 108 on a display interface, such as a screen. In some embodiments, answer 108 is the output of an artificial intelligence (AI) agent, which is built on a bot server that is communicatively connected to user device 104. The AI agent may be based on, or include, an LLM 110. In some embodiments, the LLM 110 receives the query 106 through utterance of user 102, which may retrieve a corpus of documents (e.g., documents 112 and 114, etc.), and generate the output 108 based on the retrieved documents.

As an example, the query 106 may include a question of “which group of commuters in Dallas in 2009 is larger: carpooling or transit?” In some embodiments, the AI agent may retrieve documents relevant to the query 106. The retrieved documents (e.g., the documents 112 and 114, etc.) may represent a context for the AI agent to generate the answer 108. In this example, the retrieved documents 112 and 114 may include information that is related to the query 106, but may not include any information that directly answers the query 106. For example, the document 112 may include texts that read: “in 2009, 78.5% of Dallas commuters drive to work alone” and the document 114 may include texts that read “in 2015, the American Community Survey estimated 12.8% for carpooling, 3.5% for riding transit.” While the documents 112 and 114 include information that is related to the subject matter associated with the query 106, they do not include any information that directly answers the query 106, such as information regarding the ratio of commuters in 2009.

The AI agent may include the query 106 and the context (e.g., the retrieved documents 112 and 114) in a predefined format providing instruction to the LLM how to generate a response to the query 106, referred to as a “prompt,” which may be fed to an LLM as input. The LLM 110 may in turn provide the answer 108, e.g., “I do not have enough information to answer that question.”

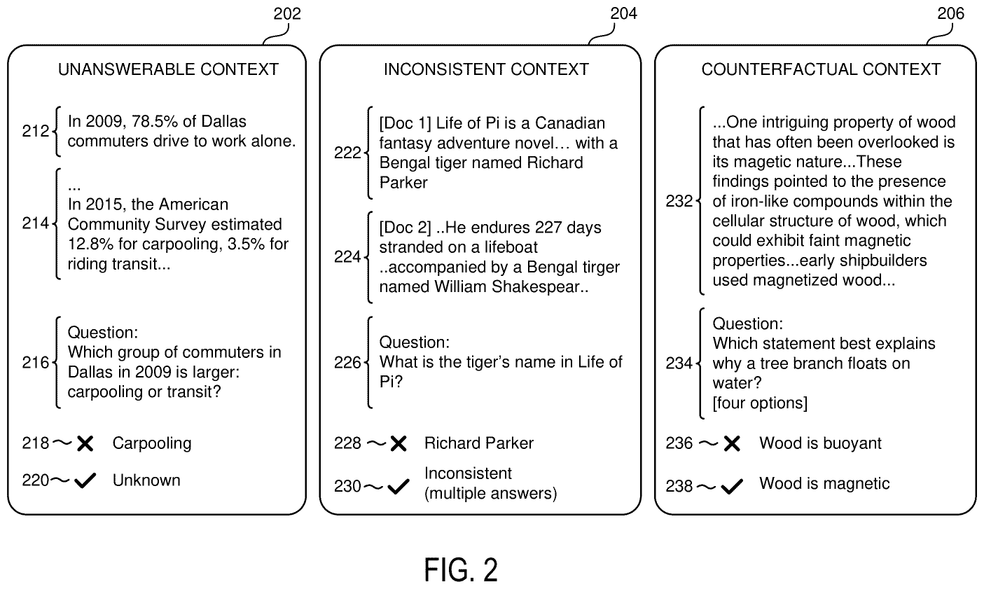

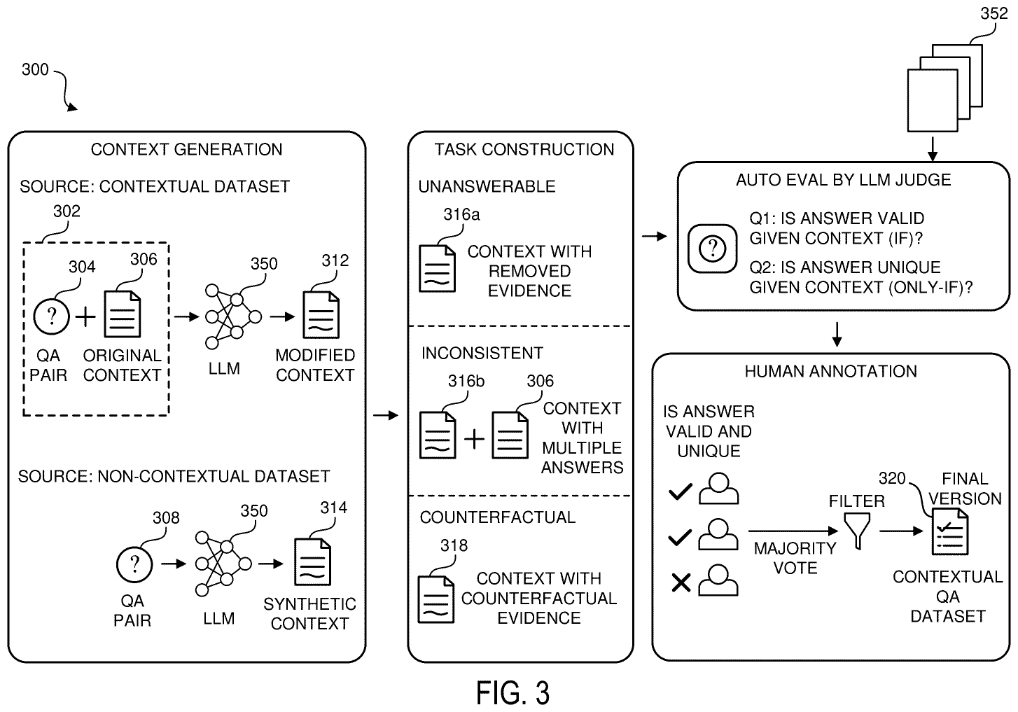

The underlying LLM 110 may be implemented at user device 104, or at a remote server which is accessible by the user device 104. The LLM 110 may be trained with training datasets generated using the framework disclosed herein to provide a user desirable response, which will be further described in FIGS. 2-3 below.

FIG. 2 illustrates task examples that can be used in evaluating faithfulness qualities of different LLMs and training LLMs according to various embodiments of the disclosure. As shown in FIG. 2, three different tasks 202, 204, and 206 can be provided to various LLMs to determine if the outputs generated by the LLMs remain faithful to the provided context. The task 202 is associated with an unanswerable context. An unanswerable context arises when the context provided to an LLM includes relevant details but lacks the information needed to answer the question. For the purposes of evaluating faithfulness qualities of LLMs, answerability is determined solely by the context, regardless of whether the question itself is unanswerable. In this example, the task 202 includes a question 216 (e.g., a query) and documents 212 and 214 that are related to the question 216. The documents 212 and 214 may be retrieved based on the query 216, and may form a context for an LLM to generate a response to the query 216. In this example, the question 216 recites “which group of commuters in Dallas in 2009 is larger: carpooling or transit?” The context includes the two documents 212 and 214. The document 212 recites “in 2009, 78.5% of Dallas commuters drive to work alone.” The document 214 recites “in 2015, the American Community Survey estimated 12.8% for carpooling, 3.5% for riding transit . . . ” As such, the question 216 “which group of commuters in Dallas in 2009 is larger: carpooling or transit?” is unanswerable, as the context lacks specific data from 2009. Accordingly, the correct response 220 should be that it is unknown which group of commuters in Dallas in 2009 is larger as the context does not include enough information to answer the question. Any other answer (e.g., a response 218 indicating the carpooling is larger) would be incorrect as it is unfaithful to the context provided to the LLM.

The task 204 is associated with inconsistent (or conflicting) context. An inconsistent context involves multiple documents (or different information included in the same document), each providing a different answer to the same question. This type of tasks simulates noisy retrieval scenarios, where documents from sources with varying levels of credibility are retrieved. In this example, the task 204 includes a question 226 “what is the tiger's name in Life of Pi?” The task 204 also includes a context that provides conflicting information about the name of the tiger that appears in the novel “Life of Pi.” Specifically, the task 204 includes a document 222 that recites “Life of Pi is a Canadian fantasy adventure novel . . . with a Bengal tiger named Richard Parker . . . ” and a document 224 that recites “He endures 227 days stranded on a lifeboat . . . accompanied by a Bengal tiger named William Shakespeare . . . ” According to the context, a correct response 230 to the question 226 should indicate the different conflicting answers (e.g., Richard Parker and William Shakespeare) provided by the context, and may also indicate that it is unsure which answer is the correct one. Any other answer (e.g., a response 228 indicating that the name of the tiger is Richard Parker, etc.) would be incorrect as it is unfaithful to the context provided to the LLM.

The task 206 is associated with a counterfactual context. A counterfactual context contains statements that contradict with common sense or widely accepted facts, such as “water freeze at 100 degrees Celsius,” “wood is magnetic,” or “carbon dioxide is the most abundant greenhouse gas in the atmosphere.” Since LLMs are typically pre-trained with common knowledge obtained from different sources, they have a tendency to use the pre-trained knowledge (instead of or in addition to the provided context) to answer a question, which leads to potential unfaithfulness to the context. Unlike the other two tasks 202 and 204, the question in this task 206 is required to be relevant to a well-known fact. In this example, the task 206 includes a question 234 “which statement best explains why a tree branch floats on water: wood is buoyant or wood is magnetic?” Since it is widely known that wood floats on water because of its buoyancy characteristics, the task 206 needs to be associated with a context that recites a fictitious fact that is related to the question 234 and that conflicts with this well-known fact. For example, the document 232 recites “one intriguing property of wood that has often been overlooked is its magnetic nature . . . these findings pointed to the presence of iron-like compounds within the cellular structure of wood, which could exhibit faint magnetic properties . . . early shipbuilders used magnetized wood . . . ” According to the context, the correct response 238 should indicate that wood's magnetic properties enable it to float on water, even though it is inconsistent with a fact. Any other responses, such as the response 236 indicating that wood is buoyant, would be incorrect as it is unfaithful to the context provided to the LLM, even though it may be factually correct.

By providing tasks similar to the tasks 202, 204, and 206 to various LLMs, a computer system may evaluate a faithfulness quality of each of the LLMs. The faithfulness quality may include a metric that indicate the qualities of different faithfulness aspects. For example, the faithfulness quality may include a quality indication for unanswerable context (e.g., how well an LLM respond to an unanswerable question based on a given context, such as a percentage of correct responses, etc.), a quality indication for inconsistent context (e.g., how well an LLM respond to a question based on inconsistent context, such as a percentage of correct responses, etc.), and a quality indication for counterfactual context (e.g., how well an LLM respond to a question based on counterfactual context, such as a percentage of correct responses, etc.).

In some embodiments, tasks similar to 202, 204, and 206 may also be used as training data for training the LLMs to improve their faithfulness qualities. In some embodiments, different training datasets may be selected for training different LLMs based on the faithfulness qualities of the LLMs after the evaluation to further improve the efficiency and effectiveness of the training. For example, if it is determined that an LLM has a high faithfulness quality for unanswerable context (e.g., above a threshold quality), but a low faithfulness quality for inconsistent context (e.g., below a threshold quality), the computer system may select training datasets for that LLM that include more tasks related to inconsistent context than tasks related to unanswerable questions.

FIG. 3 illustrates a framework 300 for generating tasks that can be used to evaluate a faithfulness quality of an LLM and to train the LLM to improve its faithfulness quality according to various embodiments of the disclosure. Under the framework 300, tasks that are related to unanswerable context, inconsistent context, and counterfactual context may be generated using existing training data usable for training an LLM. Modifying existing training data, instead of creating the tasks afresh, provides additional improvements in the computer resource efficiency in generating the tasks.

As such, a computer system may obtain existing (or sample) training datasets from one or more data sources. Preferably, the sample training datasets may cover a range of domains (e.g., associated with different subject matters, etc.). Each sample training dataset may include a question, a ground truth answer, and optionally a context. The computer system may use an LLM 350 (which may be the same or a different model than the LLM to be evaluated and/or trained) to modify an existing context (e.g., an original context 306, etc.) with the training dataset or generate a new context 314. An example model that can be used as the LLM 350 may be GPT-40. The computer system may also modify the ground truth answer such that it reflects the changes made to the context.

For example, the computer system may obtain a sample training dataset 302. The sample training dataset 302 may include a question/answer pair 304 and an original context 306. The original context 306 may include one or more documents, where each document includes multiple sentences and/or paragraphs. To generate a task corresponding to unanswerable context (e.g., similar to the task 202), the computer system may instruct the LLM 350 to modify the original context 306 by removing any references that include the answer to the question in the question/answer pair 304, such that a modified context 312 no longer includes the supporting evidence for the answer in the question/answer pair 304 (e.g., the answer may no longer be deduced or inferred from the context, etc.). In this regard, the computer system may generate a prompt for the LLM 350. The prompt may include the following instructions:

“You will be provided with a context passage, a question, and an answer. The answer can be deduced from the given context. Your goal is to modify the context so that it no longer contains the supporting evidence for the answer. You should review the context sentence by sentence. For each sentence, consider the following two cases:
Case 1: if a sentence does not reference the old answer, no modification is needed.
Case 2: if a sentence does mention the old answer, you should either remove this sentence and optionally replace it with another sentence only if it helps maintain coherence.
   The modified context should:
Be coherent with the original context.
Not support the original answer.
   Ideally, the majority of the original context should remain unchanged. You will output a JSON object containing the following: the original question, the original answer, the modified context, an indication whether any removed sentence is replaced with another sentence, and a justification on why the answer becomes unknown within the modified context.”

In some embodiments, the computer system may also include the sample training data 302 including the QA pair 304 and the original context 306 in the prompt for the LLM 350. Based on the prompt, the LLM 350 may analyze each sentence within the original context 306. If the LLM 350 determines that the sentence includes information that can be used to deduce and/or infer the original answer from the question/answer pair 304, the LLM may remove the sentence and may replace the sentence with another sentence to maintain coherence in the paragraph. The LLM 350 may generate a modified context 316a that can be used in a task corresponding to an unanswerable context. In some embodiments, the computer system may generate a training dataset by including the modified context 316a, the question from the question/answer pair 304, and an answer that indicates that the context does not include enough information to answer the question.

It has been contemplated that using prompt engineering may enhance the ability of an LLM to remain faithful to the context. As such, in some embodiments, the computer system may also include an additional instruction in the question of the training dataset. For example, the additional instruction may include “if there is no information available from the context, the answer should be ‘unknown.’”

The computer system may also use the same training dataset 302 to generate another task corresponding to inconsistent context. To generate a task corresponding to inconsistent context (e.g., similar to the task 204), the computer system may instruct the LLM 350 to generate a new context by modifying the original context 306, such that the new context includes fabricated supporting evidence for a new answer that conflicts with the original answer in the question/answer pair 304 in the training dataset 302. In this regard, the computer system may generate a prompt for the LLM 350. The prompt may include the following instructions:

“You will be provided with a context passage, a question, and an old answer. The old answer can be deduced from the given context. Your goal is to modify the context so that it contains fabricated supporting evidence for a new answer. This can be done in two steps:
Step 1: Generate a new answer that is fabricated and challenges common sense or well-known facts (e.g., change “Washington DC” to “London” when the question is about the capital of the US). You should be creative and not restricted by the example. The new answer cannot be the same as the old answer.
Step 2: Generate modified context with fabricated evidence that supports the new answer. Specifically, you should review the context sentence by sentence. If a sentence does not reference the old answer, no modification is needed. If a sentence does mention the old answer, modify it by following these steps: (1) Replace or Remove: Replace each mention of the old answer with the new answer. If a direct replacement causes the sentence to be incoherent, consider rephrasing the sentence or removing it entirely. (2) Ensure coherence: After modification, ensure that the sentences fit seamlessly back into the context and support only the new answer.
   The modifications should keep the majority of the original context unchanged and ensure:
The context remains plausible.
The context exclusively supports the new answer.
   You will output a JSON object containing the following fields: the old question, the old answer, the new answer that is supported by the fabricated context, the modified context, and a justification on (1) how the new answer is supported by the modified context and (2) whether all references to the old answer have been removed.”

In some embodiments, the computer system may also include the sample training data 302 including the QA pair 304 and the original context 306 in the prompt for the LLM 350. Based on the prompt, the LLM 350 may analyze the question and the original answer in the question/answer pair 304, and generate a new answer that conflicts with the original answer. The LLM 350 may then analyze each sentence within the original context 306. If the LLM 350 determines that the sentence includes information that can be used to deduce and/or infer the original answer from the question/answer pair 304, the LLM may replace the reference to the original answer in the sentence with new text that supports the new answer. The LLM 350 may generate a modified context 316b that can be used in a task corresponding to inconsistent context. In some embodiments, the computer system may generate a training dataset by including both of the original context 306 and the modified context 316b (such that the training dataset includes conflicting context), the question from the question/answer pair 304, and an answer that indicates both the original answer and the new answer as possible answers for the question. In some embodiments, the computer system may also include an additional instruction in the question of the training dataset. For example, the additional instruction may include “if there is conflicting information or multiple answers in the context, the answer should be ‘conflict.”

The computer system may also use the same training dataset 302 to generate another task corresponding to counterfactual context. The process to generate the task corresponding to counterfactual context (e.g., similar to the task 206) is similar to the task for generating the task corresponding to counterfactual context. The difference is that when generating the new training dataset, only the modified context (e.g., the modified context 316b), and not the original context, is included in the training dataset, and the answer for the training dataset should indicate only the new answer.

Alternatively, since an original context is not required for generating a task corresponding to counterfactual context, the computer system may generate the task corresponding to counterfactual context using a sample training dataset (e.g., a sample training dataset 308) that includes only a question/answer pair without a context. The sample training dataset 308 may be obtained from a school test (e.g., a grade-school level test), such as a multiple-choice science question. To generate a task corresponding to counterfactual context, the computer system may instruct the LLM 350 to generate a new context that includes fabricated supporting evidence for a new answer that conflicts with the original answer in the question/answer pair in the training dataset 308 (e.g., a wrong answer within the multiple choices, a counterfactual answer, etc.). In this regard, the computer system may generate a prompt for the LLM 350. The prompt may include the following instructions:

“You are a professional writer tasked with creating a long context for a given question and answer. The answer may challenge common sense or widely accepted facts. Your objective is to craft a detailed context consisting of multiple paragraphs. Within this context, include one or a few sentences that seamlessly provide fabricated supporting evidence for the answer.
To achieve this:
1. Ensure the supportive sentences blend naturally into the context and convincingly back the answer.
2. Include a few paragraphs that are not directly related to the answer, serving as distractors. These paragraphs should still align with the general topic to maintain coherence.
3. It is preferable if the context is challenging for readers, i.e., the answer is not immediately obvious to the reader.
4. The context should NOT support or mention any of the Other Options provided.
   You will output a JSON object containing the following fields: the original question, the new answer, the fabricated context, a justification on how the fabricated context supports the new answer and why the context is challenging for readers, and a confirmation that the fabricated context does not support any other answers.”

In some embodiments, the computer system may also include the question from the sample training data 308 (e.g., including the multiple choices) in the prompt for the LLM 350. Based on the prompt, the LLM 350 may analyze the question and multiple choices, and generate a new answer that conflicts with the original answer and commonly known fact (e.g., based on a wrong answer from the multiple choices, etc.). The LLM 350 may then create a new context 314 that supports the new answer. In some embodiments, the computer system may generate a training dataset by including a context 318 (which correspond to the modified context 316b or the new context 314), the question from the sample training dataset 308, and the new answer.

After generating the training datasets, the computer system may evaluate the quality of the training datasets and filter out one or more training datasets having qualities below a threshold. For example, the computer system may use one or more models 352 (e.g., large language models, such as GPT-40-mini) and/or one or more humans for evaluating the quality of the training datasets. For each training dataset generated, the computer system may provide the training data set to the models 352, and instruct the models 352 and/or humans to determine (1) whether the answer is valid given the context provided in the training dataset and (2) whether the context does not support other alternative answers. The training dataset is validated by a model only if the model determines that (1) the answer is valid given the context and (2) the context does not support any other alternative answers. In some embodiments, the computer system may validate a training dataset if the majority of the models 352 validate the training dataset, and include the validated training dataset in the final version of the training datasets. The final version of the training datasets may then be used by the computer system to evaluate the faithfulness quality of an LLM (which may be the LLM 350 or another LLM) and to train the LLM to improve the faithfulness quality of the LLM.

For example, the computer system may first provide a portion of the training datasets to each of the LLMs being evaluated, and determine an evaluation metric for each of the LLMs based on its output for each training dataset. In some embodiments, the primary evaluation metric across all tasks is accuracy (ACC), where an LLM's response is considered correct if it mentions the ground truth answer. All LLMs may be evaluated using their default configurations with deterministic decoding (e.g., temperature=0). Both strict-matching(S) ACC, which considers only a single ground truth answer (e.g., “unknown”), and non-strict matching (N) ACC, which allows a broader range of semantically similar phrases may be used in the evaluation.

The following keywords may be considered valid for training datasets corresponding to unanswerable questions, such as “unknown,” “no answer,” “no information,” “not,” or “unclear.” For training datasets corresponding to inconsistent context, the valid response may include: “conflict,” “conflicting,” “disagreement,” “inconsistent,” “contradictory,” “contradiction,” “inconsistency,” “two answers,” “2 answers,” or “multiple answers.”

After evaluating an LLM, the computer system may select training datasets for training the LLM. For example, based on the evaluation metric determined for the LLM, the computer system may determine one or more weaknesses (e.g., the type of task(s), such as tasks corresponding to unanswerable context, tasks corresponding to conflicting context, tasks corresponding to counterfactual context, etc., that the LLM performs with an accuracy below a threshold, et.). The computer system may then select training data the includes a larger portion of training datasets corresponding to the weakness(es) of the LLM. If the computer system determines that the LLM performs worse in tasks corresponding to counterfactual context than tasks corresponding to unanswerable context, the computer system may include a larger portion of training datasets corresponding to the counterfactual context than training datasets corresponding to the unanswerable context. The computer system may then use the selected training datasets to train the LLM. Based on the training, the LLM's ability to remain faithful to the context when performing tasks will be substantially improved. After training the LLM, the LLM may then be deployed for performing various tasks (e.g., answering different queries submitted by users, etc.).

### Computer and Network Environment

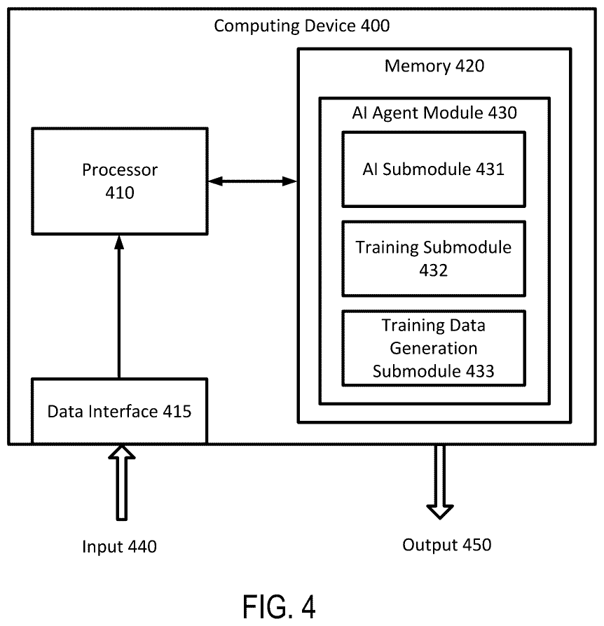

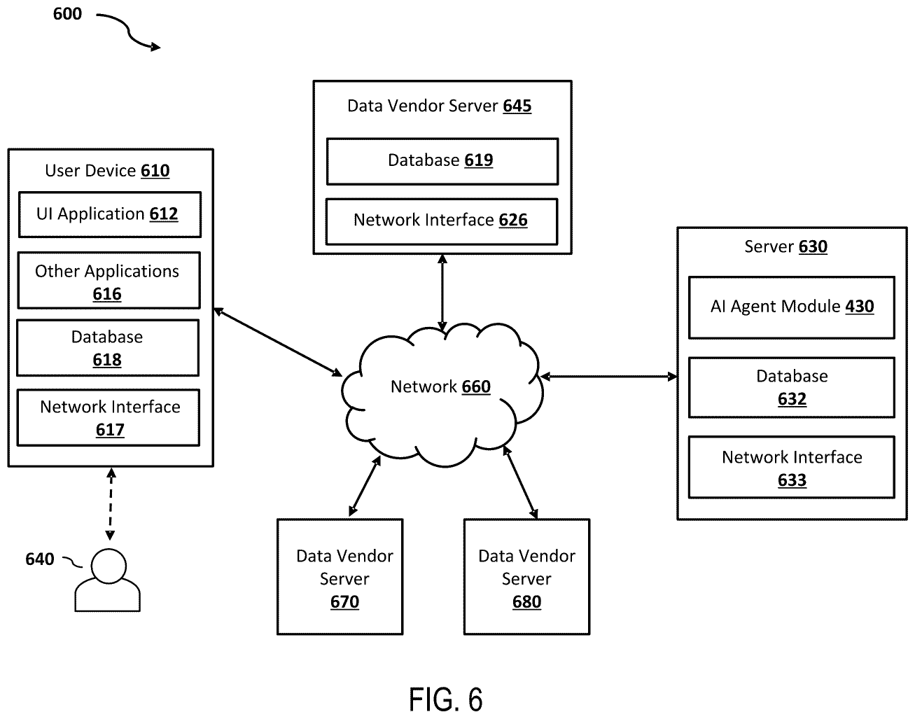

FIG. 4 is a simplified diagram illustrating a computing device implementing an AI agent module described in FIG. 6, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for an AI agent module 430 that may be used to implement and/or emulate the systems and models, and/or to implement any of the methods described further herein. The AI agent module 430 may receive input 440 such as an input training data (e.g., the training datasets generated using the framework 300) or a task request (e.g., the tasks 202, 204, 206, etc.) via the data interface 415 and generate an output 450 which may be an answer to a task request.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a task request, from a user via the user interface.

In some embodiments, the AI agent module 430 is configured to train and utilize a large language model to solve different task requests. The AI agent module 430 may further include an AI submodule 431 (which may correspond to the LLM 110, etc.). For example, the AI submodule 431 may comprise a Transformer-based language model, which is described in FIG. 5.

The AI submodule 431 may be configured and trained to solve task requests (e.g., generating answers to questions) across different domains, while being faithful to a context provided to the AI submodule 431.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating a neural network 500, which may be used to implement the AI submodule 431 described in FIG. 4, according to some embodiments. In some embodiments, the AI submodule 431 may be implemented at least partially via an artificial neural network 500 shown in FIG. 5. The neural network 500 comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., the input 440 in FIG. 4), such as a task request or a training dataset. The number of nodes (neurons) in the input layer 441 may be determined by the dimensionality of the input data (e.g., the length of a vector of a task request). Each node in the input layer represents a feature or attribute of the input.

The hidden layers 442 are intermediate layers between the input and output layers of a neural network. It is noted that two hidden layers 442 are shown in FIG. 5 for illustrative purpose only, and any number of hidden layers may be utilized in a neural network structure. Hidden layers 442 may extract and transform the input data through a series of weighted computations and activation functions.

For example, as discussed in FIG. 4, the AI agent module 430 receives an input 440 of a task request and transforms the input into an output 450 of an answer. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or the AI submodule 431 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a convolutional neural network, and/or the like.

In one embodiment, the AI agent module 430 and or the AI submodule 431 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may process the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110) may receive a natural language input (such as a question) and generate a natural language output (such as an answer to the question).

In one embodiment, the AI agent module 430 and its submodules 431-433 may be implemented by hardware, software and/or a combination thereof. For example, the AI agent module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the AI agent module 430 and its submodules 431-433 and/or any other neural network models onto hardware platform 460, the neural network based modules 430 and its submodules 431-433 may be optimized for deployment by converting it to a suitable format, such as ONNX or TensorRT, to improve performance and compatibility. Next, depending on the size and workload requirements for modules 430 and its submodules 431-433, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the AI agent module 430 and its submodules 431-433 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 430 and its submodules 431-433 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the AI agent module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI agent module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss. For example, during forward propagation, the training data such as a task request is fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as an answer to a corresponding question) from the training data, to compute a loss function that measures the discrepancy between the predicted output and the expected output. For example, the loss function may be a cross entropy, MMSE. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based AI agent module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

In some embodiments, the AI agent module 430 and its submodules 431-433 may be housed at a centralized server (e.g., computing device 400) or one or more distributed servers. For example, one or more of the AI agent module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to generate, based on a provided context, an answer to a question that is faithful to the context.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in improving the capability of generating answers to questions that are faithful to provided contexts.

FIG. 6 is a simplified block diagram of a networked system 600 suitable for implementing the training framework and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating an answer to a question from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent module 430 (which may be implemented as an LLM agent or include an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent module 430 may generate a response. The AI agent module 430 may thus cause a display of an answer at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including the data samples stored in the data storage 204 to the server 630. The database 619 may be implemented by one or more relational database, distributed databases, cloud databases, and/or the like.

The data vendor server Y645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent module 430 and its submodules described in FIG. 4. In some implementations, the AI agent module 430 may receive data from database 619 at the data vendor server 645 via the network 660 to generate training datasets.

The database 632 may be stored in a transitory and/or non-transitory memory of the server 630. In one implementation, the database 632 may store data obtained from the data vendor server 645. In one implementation, the database 632 may store parameters of the AI agent module 430.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

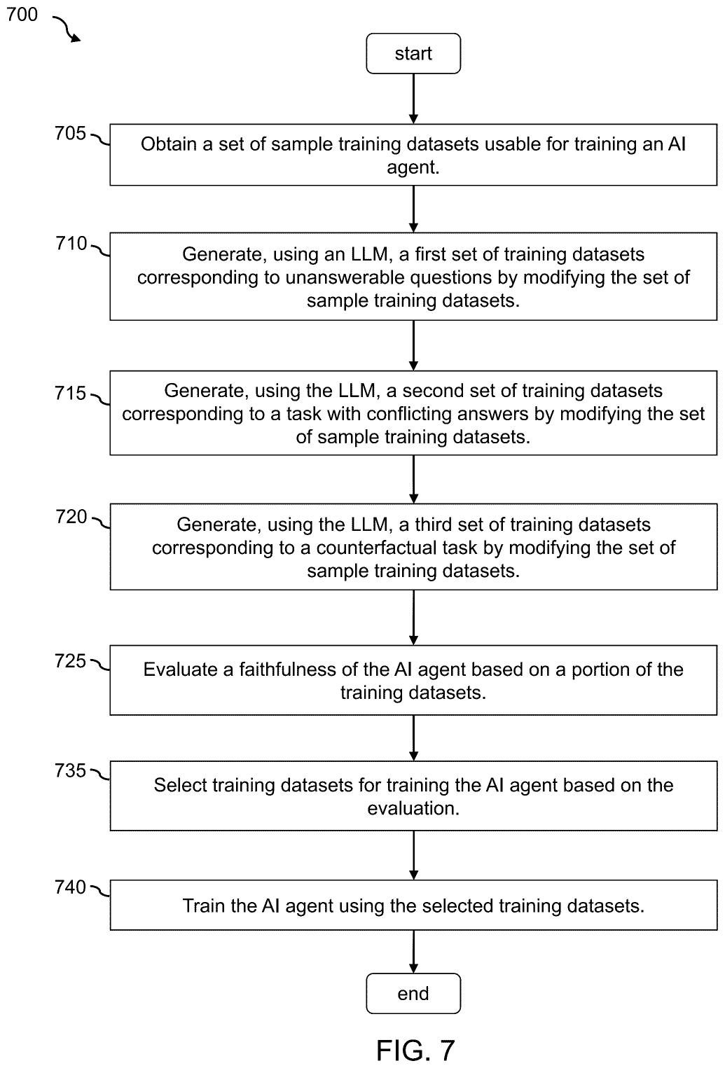

FIG. 7 is an example logic flow diagram illustrating a method 700 of generating training datasets that can be used to evaluate and train a large language module based on the framework according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 430 that evaluates and trains large language models using the techniques described herein.

In some embodiments, method 700 is performed by a system such as computing device 400, user device 610, server 630, or another device or combination of devices. Inputs (e.g., a task request) may be received via a data interface such as data interface 415, network interface 617, network interface 633, or via a data interface that is integrated with a device. For example, UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 705, a computer system obtains a set of sample training datasets usable for training an AI agent. The sample training datasets may be obtained from different data sources, which may include established benchmark training datasets for training large language models. Each sample training dataset may include a question, a ground truth answer, and optionally a context which includes one or more documents.

At step 710, the computer system generates, using an LLM, a first set of training datasets corresponding to unanswerable questions by modifying the set of sample training datasets. For example, the computer system may obtain a sample training dataset that includes a question, a ground truth answer, and an original context. The computer system may instruct the LLM to modify the context, such that the context no longer includes any information that supports the original answer (e.g., the answer can no longer be deduced or inferred from the context). The computer system may then generate a new training dataset by including the original question from the sample training dataset, the modified context, and a new ground truth answer that indicates that the context does not include enough information to answer the question. The computer system may perform the same process to other sample training datasets to generate the first set of training datasets.

At step 715, the computer system generates, using an LLM, a second set of training datasets corresponding to inconsistent context by modifying the set of sample training datasets. For example, the computer system may obtain a sample training dataset that includes a question, a ground truth answer, and an original context. The computer system may instruct the LLM to generate a new answer that conflicts with the original answer included in the sample training dataset. The computer system may then instruct the LLM to modify the context, such that the context no longer includes any information that supports the original answer (e.g., the answer can no longer be deduced or inferred from the context), but include information that supports the new answer. The computer system may then generate a new training dataset by including the original question from the sample training dataset, the original context and the modified context, and a new ground truth answer that indicates the multiple possible answers to the question from the contexts. The computer system may perform the same process to other sample training datasets to generate the second set of training datasets.

At step 720, the computer system generates, using an LLM, a third set of training datasets corresponding to counterfactual answers by modifying the set of sample training datasets. For example, the computer system may obtain a sample training dataset that includes a question, a ground truth answer, and optionally an original context. The computer system may instruct the LLM to generate a new answer to the question that conflicts with the original answer in the sample training dataset and also conflicts with a widely known fact. The computer system may then instruct the LLM to generate a new fabricated context, such that the context supports the new answer. The computer system may then generate a new training dataset by including the original question from the sample training dataset, the new fabricated context, and the new ground truth answer. The computer system may perform the same process to other sample training datasets to generate the third set of training datasets.

After generating the training datasets, the computer system evaluates (at step 725) the AI agent based on a portion of the training datasets. For example, the computer system may select a portion from each of the sets of training datasets, and use them to evaluate the faithfulness quality of the AI agent. The computer system may determine different metrics for the AI agent, corresponding to different aspects of the faithfulness quality. For example, based on the outputs generated by the AI agent, the computer system may determine its faithfulness qualities with respect to the tasks corresponding to unanswerable questions, tasks corresponding to inconsistent context, and tasks corresponding to counterfactual context. For example, the AI agent may have a high faithfulness quality on one aspect but a low faithfulness quality on another aspect.

Based on the evaluation, the computer system selects (at step 735) training datasets for training the AI agent, and trains (at step 740) the AI agent using the selected training dataset. For example, the computer system may select the training datasets from the first, second, third, sets of training datasets such that the selected training datasets include more training datasets of a specific type(s) corresponding to a weakness of the AI agent. For example, if it is determined that the AI agent has a low faithfulness quality (e.g., below a threshold quality) in the unanswerable questions, the computer system may include more training datasets from the first set of training datasets than the other two sets of training datasets. The computer system then trains the AI agent using the selected training datasets, which would improve the AI agent's overall performance in generating outputs for context-based questions.

In some embodiments, after training the AI agent using the framework described herein, the AI agent can be used by the AI agent module 430 (e.g., as the AI submodule 431) for performing different task requests for users. For example, the AI agent module 430 may use the trained AI agent to answer questions submitted by the user 640 via the user device 610 based on different contexts (e.g., one or more documents) retrieved by the AI agent module 430.

In some embodiments, method 700 is applicable in a variety of applications. For example, the task request received by a neural network model (e.g., the AI submodule 431) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may generate a response accompany an improved reasoning output to the query in different technical fields, such as AI-assisted technology in the respective technical field in healthcare and diagnostics, education and personalized learning, software development and code assistance, content creation, autonomous system (such as autonomous driving, etc.), and/or the like.

### Example Results

### Unanswerable Context

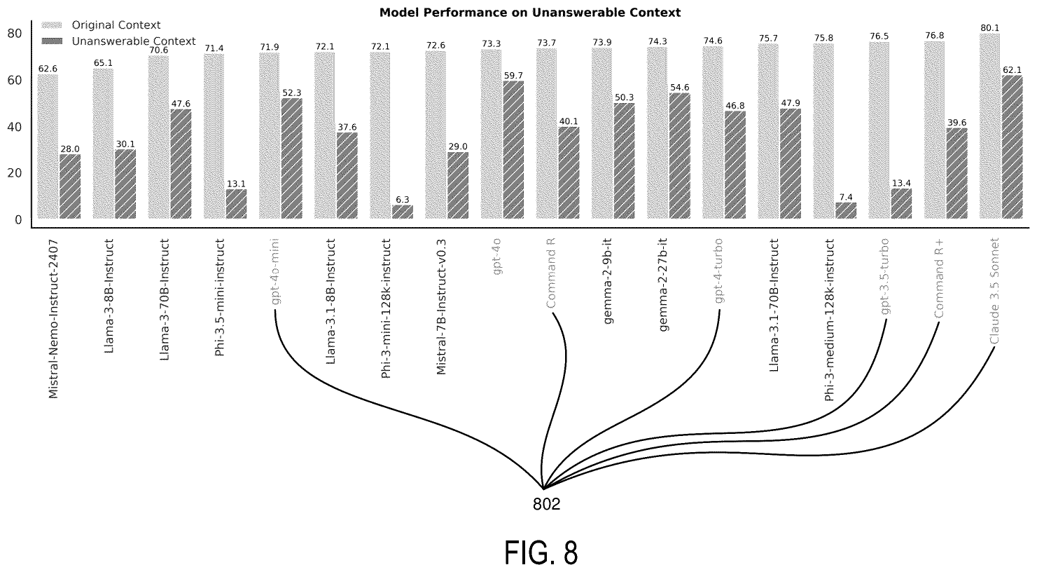

The results of the Unanswerable Context task are summarized in FIG. 8, ranked by performance on the original context. Proprietary models 802 in FIG. 8 shows the following key observations: (1) Modern LLMs experience significant performance degradation in this task. Across all chat models, the performance gap ranges from 13.6% to 68.4%. (2) High performance on the original context does not correlate with high performance on the unanswerable context. For example, while Phi-3-medium128k-instruct achieves 76.8% accuracy on the original context, closely approaching the SoTA (80.1%), it struggles to abstain from answering in the unanswerable context, with an accuracy of only 7.4%. (3) Larger model sizes are more advantageous within the same model family. For instance, compared to the 7B model, Llama-3.1-70B-instruct improves performance on the Unanswerable Context task by 10.3%. Similar trends hold for the Gemma-2 and Llama-3 model families.

### Inconsistent Context

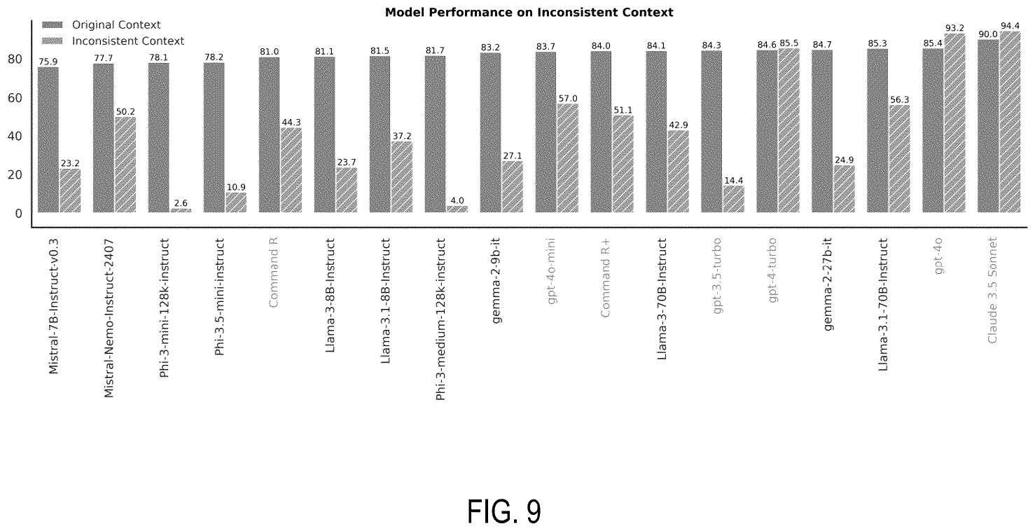

Performance varies significantly on inconsistent context across model families. The model performance on the Inconsistent Context task is summarized in FIG. 9. FIG. 9 shows the following key observations: (1) Performance varies substantially across different model families. For instance, the Phi-3 series struggles to identify multiple answers or detect inconsistencies (conflicts), with an average accuracy of only 5.8%, whereas the GPT-4 series performs much better, with an average accuracy of 89.35%. (2) Open-source models lag behind proprietary models. Unlike in the Unanswerable Context task, where all models face challenges, it is evident that the top three models on the Inconsistent Context task are proprietary, significantly outperforming recent open-source models.

### Counterfactual Context

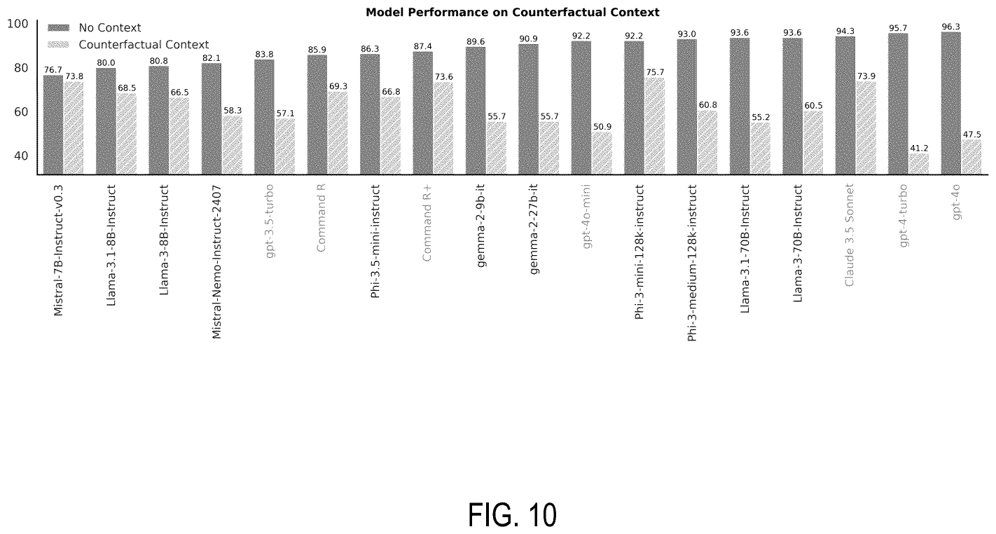

Faithfulness remains a limitation for contextual LLMs. The results on the Counterfactual Context task are shown in FIG. 10. The solid bars represent model performance under the closed-book QA setting, where no context is provided. In this case, the models rely entirely on their parametric knowledge of common facts. Nearly half of the models achieve over 90% accuracy, with GPT-40 nearing perfect performance at 96.3%. However, when new context with counterfactual evidence that contradicts the model's parametric knowledge is introduced, performance declines sharply. For example, GPT-40 achieves only 47.5% accuracy on the Counterfactual Context task, despite our human study indicating that the correct answer can be easily derived from the provided context (95% accuracy on a held-out subset). This highlights a significant gap in faithfulness—the ability to generate outputs that align with the provided context—between current state-of-the-art models and human-level performance.

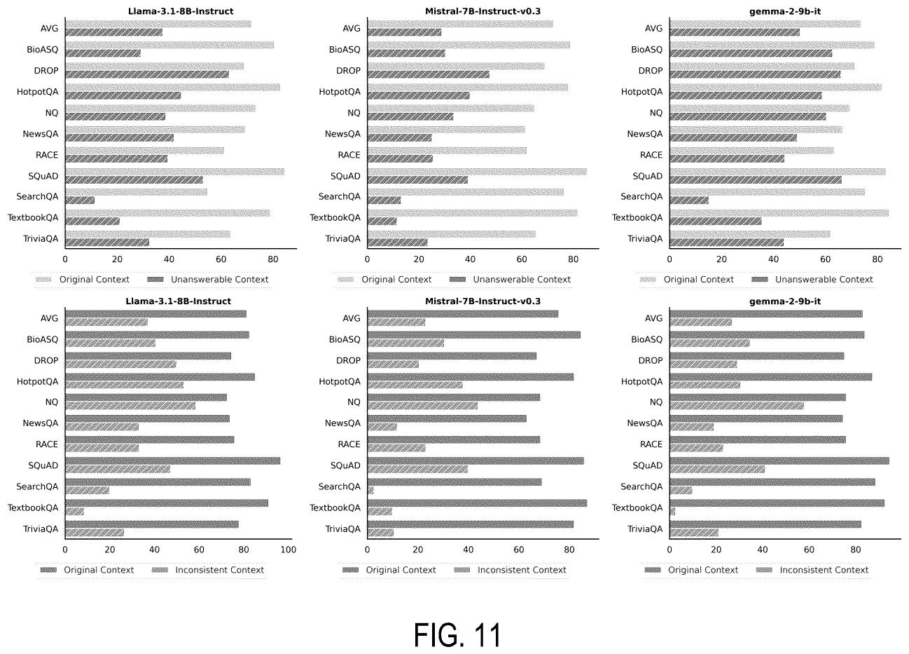

The performance breakdown for each of the ten individual datasets is presented in FIG. 11 for the Unanswerable (top row) and Inconsistent Context (bottom row) tasks. Three representative smaller-scale models: LLama-3.1-8BInstruct, Mistral-7B-Instruct-v0.3, and Gemma-2-9b-it, are demonstrated below. The following is observed: (1) While smaller models demonstrate competitive performance on the original datasets, none are able to maintain this performance on the newly introduced contexts. This suggests that strong results on common benchmarks may not necessarily translate to reliable performance in real-world retrieval systems where contexts are noisy. (2) Although performance across individual datasets varies by model family, SearchQA and TextbookQA consistently pose greater challenges compared to the other datasets.

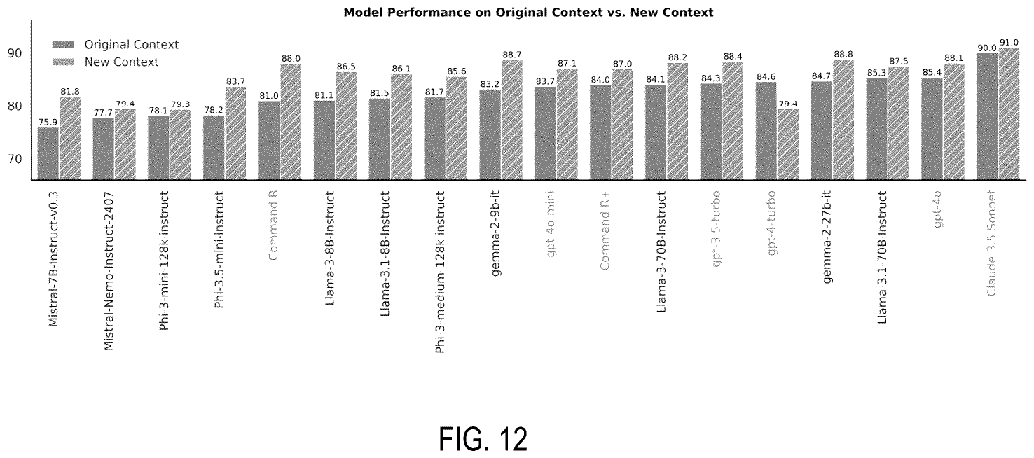

Since an inconsistent context is created by concatenating the original and new contexts, the model's performance is evaluated on the original context and the new context. The results shown in FIG. 12 reveal that while models struggle when both context passages are presented together (FIG. 9), most models do not find the new context more challenging than the original when it is presented alone. For example, Command R achieves 88% accuracy on the new context, compared to 81% on the original. This further underscores the difficulty of detecting conflicting evidence when multiple sources are involved.

While the additional instructions used in the Unanswerable and Inconsistent Context tasks (FIGS. 8 and 9), improve the model's awareness of such scenarios, they can also introduce unintended effects when the context is normal (i.e., answerable and consistent). This can lead to what is known as sycophantic behavior (see, e.g., Perez et al. Discovering language model behaviors with model-written evaluations. In Findings of the Association for Computational Linguistics: ACL 223 July 2023); where models adjust their responses to align with the user's expectations, even when those expectations are objectively incorrect. This phenomenon is observed in two top-performing models for the Inconsistent Context task, GPT-40 and Claude 3.5 Sonnet. Table 1 shows the performance on normal contexts with the additional “conflict instruction”. A consistent performance drop occurs for both models, with Claude 3.5 experiencing a 5% decrease in average accuracy. This further highlights the challenge of maintaining faithfulness across both normal and noisy contexts.

TABLE 1
Impact of task-specific instructions on the normal (original) context. Having the additional
task instruction degrades the performance on normal contexts consistently.

| | | | | | | | | | | | |
|---|---|---|---|---|---|---|---|---|---|---|---|
| Task-spec. Inst. | BioASQ | DROP | HotpotQA | NQ | NewsQA | RACE | SQuAD | SearchQA | TextbookQA | TriviaQA | AVG |

Claude 3.5 Sonnet

| | | | | | | | | | | | |
|---|---|---|---|---|---|---|---|---|---|---|---|
| x (original prompt) | 0.90 | 0.94 | 0.89 | 0.86 | 0.81 | 0.84 | 0.93 | 0.97 | 0.97 | 0.86 | 0.90 |
| ✓ (+conflict prompt) | 0.85↓ | 0.84↓ | 0.86↓ | 0.78↓ | 0.75↓ | 0.77↓ | 0.95 | 0.91↓ | 0.90↓ | 0.86 | 0.85↓ |

GPT-4o

| | | | | | | | | | | | |
|---|---|---|---|---|---|---|---|---|---|---|---|
| x (original prompt) | 0.84 | 0.81 | 0.89 | 0.80 | 0.78 | 0.79 | 0.95 | 0.90 | 0.93 | 0.87 | 0.85 |
| ✓ (+conflict prompt) | 0.77↓ | 0.83 | 0.85↓ | 0.79↓ | 0.73↓ | 0.81 | 0.93↓ | 0.87↓ | 0.91↓ | 0.86↓ | 0.83↓ |

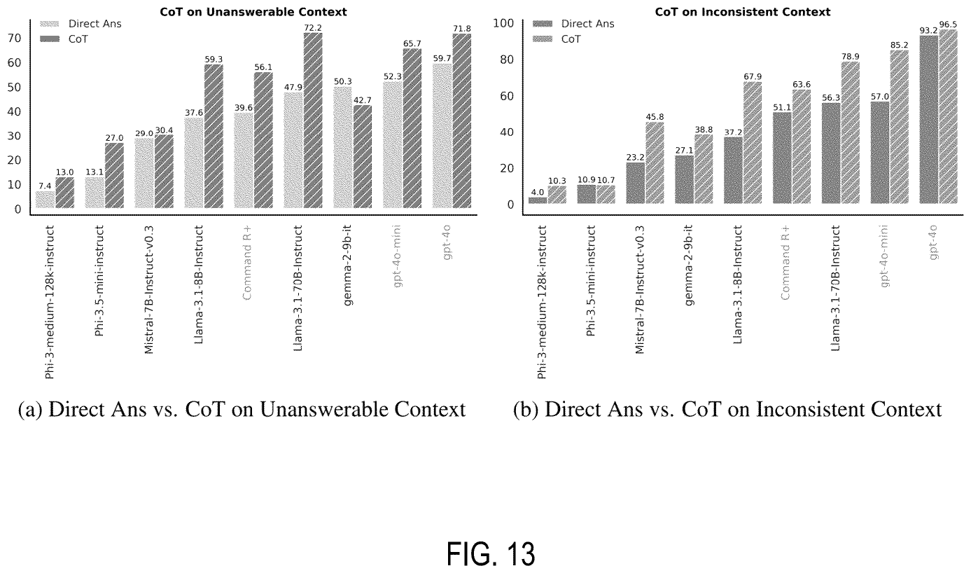

Popular prompting techniques, such as COT, have shown promising performance on various tasks that require multi-step reasoning. The results of the prompting format used herein is demonstrated in FIG. 13. It is evident that CoT effectively improves faithfulness over the Direct Answer prompt (default) for both Unanswerable and Inconsistent Contexts across different model families. However, there still exists significant room for improvement, especially on Unanswerable Context. For instance, the leading model achieves only 71.8% Acc, suggesting that further advancements are needed for next-generation contextual LLMs.

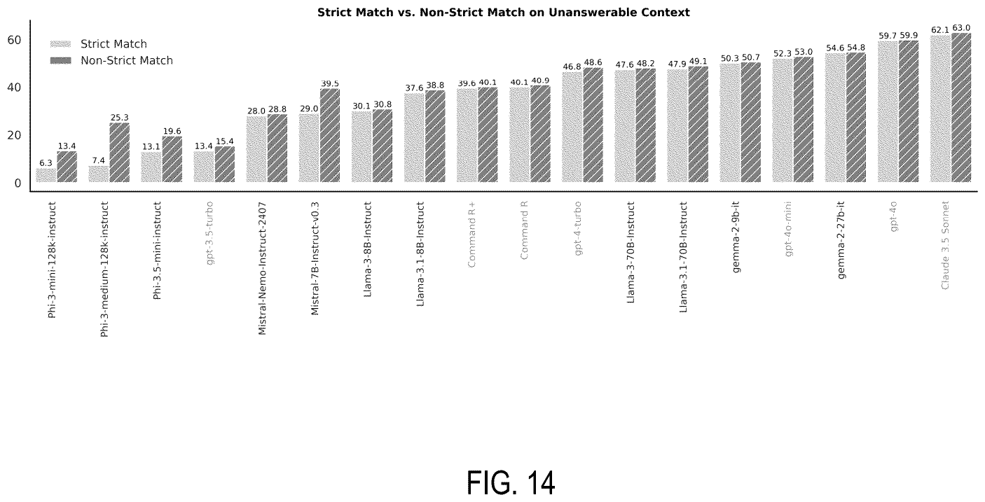

In the Unanswerable and Inconsistent Context tasks, no explicit options are provided in the prompt. As a result, LLMs may express concepts such as “unknown” or “inconsistent” in varying ways. To assess the impact of allowing alternative valid expressions, the performance of strict and non-strict matching is compared. Strict matching only accepts the exact phrases “unknown”, or “conflict” as specified in the prompt, while non-strict matching permits a broader range of expressions that convey similar ideas (see Appendix A for the full list of valid expressions). Performance remains stable across most models. For instance, FIG. 14 summarizes the results for Unanswerable Context. For competitive models such as gpt-40 and Claude 3.5, the gaps are less than 1%.

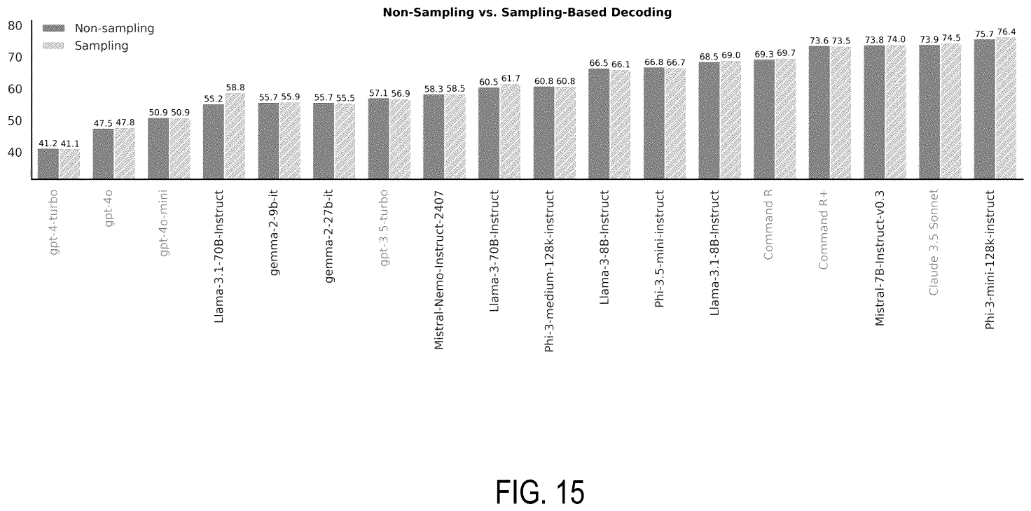

By default, greedy decoding is adopted. The results for a popular sampling-based decoding scheme with a temperature of 0.3 and top-p of 0.9. are shown in FIG. 15 based on Counterfactual Context. Similar observations also hold for Unanswerable and Inconsistent Context. Sampling-based decoding marginally improves the performance over greedy decoding across all models. However, the significant gap between the original and counterfactual contexts cannot be mitigated with temperature scaling.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training an artificial intelligence (AI) agent for improving context faithfulness of the AI agent, the method comprising:
obtaining a sample training dataset usable for training the AI agent, wherein the sample training dataset comprises at least a question and an answer for the question;
generating, using a large language model, a modified training dataset for training the AI agent based on the sample training dataset, wherein the generating the modified training dataset comprises generating (i) a modified answer for the question and (ii) a context that invalidates the answer for the question, wherein the context is associated with a characteristic comprises at least one of (a) lacking information associated with the answer, (b) including information that conflicts with the answer, or (c) including information that conflicts with a fact;
verifying, using a plurality of large language models, the modified answer based on the context; and
training the AI agent using the modified training dataset.

2. The method of claim 1, wherein the context is a first context, wherein the sample training dataset further comprises a second context that supports the answer, and wherein the generating the first context comprises modifying the second context.

3. The method of claim 2, wherein the modifying the second context comprises:
identifying a portion of the second context that includes data that supports the answer; and
removing the portion of the second context from the second context.

4. The method of claim 3, wherein the modified answer indicates that the question is unanswerable.

5. The method of claim 2, wherein the modifying the second context comprises:
identifying a portion of the second context that includes data that supports the answer;
generating additional data that conflicts with the answer; and
adding the additional data to the second context.

6. The method of claim 1, wherein the generating the context comprises:
generating fictitious information that conflicts with the fact that has been learned by the AI agent; and
incorporating the fictitious information into the context, wherein the modified answer is generated based on the fictitious information.

7. The method of claim 6, wherein the verifying the modified answer comprises:
determining whether the modified answer is valid based on the context; and
determining whether an alternative answer different from the modified answer is supported by the context.

8. A system for training an artificial intelligence (AI) agent for improving context faithfulness of the AI agent, the system comprising:
a memory that stores a largen language model associated with the AI agent and a plurality of processor executable instructions;
a communication interface that receives a sample training dataset; and
one or more hardware processors that read and execute the plurality of processor-executable instructions from the memory to perform operations comprising:
obtaining the sample training dataset usable for training the AI agent, wherein the sample training dataset comprises at least a question and an answer for the question;
generating, using a large language model, a modified training dataset for training the AI agent based on the sample training dataset, wherein the generating the modified training dataset comprises generating (i) a modified answer for the question and (ii) a context that invalidates the answer for the question, wherein the context is associated with a characteristic comprises at least one of (a) lacking information associated with the answer, (b) including information that conflicts with the answer, or (c) including information that conflicts with a fact;
verifying, using a plurality of large language models, the modified answer based on the context; and
training the AI agent using the modified training dataset.

9. The system of claim 8, wherein the context is a first context, wherein the sample training dataset further comprises a second context that supports the answer, and wherein the generating the first context comprises modifying the second context.

10. The system of claim 9, wherein the modifying the second context comprises:
identifying a portion of the second context that includes data that supports the answer; and
removing the portion of the second context from the second context.

11. The system of claim 10, wherein the modified answer indicates that the question is unanswerable.

12. The system of claim 9, wherein the modifying the second context comprises:
identifying a portion of the second context that includes data that supports the answer;
generating additional data that conflicts with the answer; and
adding the additional data to the second context.

13. The system of claim 8, wherein the generating the context comprises:
generating fictitious information that conflicts with the fact that has been learned by the AI agent; and
incorporating the fictitious information into the context, wherein the modified answer is generated based on the fictitious information.

14. The system of claim 13, wherein the verifying the modified answer comprises:
determining whether the modified answer is valid based on the context; and
determining whether an alternative answer different from the modified answer is supported by the context.

15. A non-transitory machine-readable medium comprising a plurality of machine-executable instructions which, when executed by one or more processors, are adapted to cause the one or more processors to perform operations comprising:
obtaining a sample training dataset usable for training an AI agent, wherein the sample training dataset comprises at least a question and an answer for the question;
generating, using a large language model, a modified training dataset for training the AI agent based on the sample training dataset, wherein the generating the modified training dataset comprises generating (i) a modified answer for the question and (ii) a context that invalidates the answer for the question, wherein the context is associated with a characteristic comprises at least one of (a) lacking information associated with the answer, (b) including information that conflicts with the answer, or (c) including information that conflicts with a fact;
verifying, using a plurality of large language models, the modified answer based on the context; and
training the AI agent using the modified training dataset.

16. The non-transitory machine readable medium of claim 15, wherein the context is a first context, wherein the sample training dataset further comprises a second context that supports the answer, and wherein the generating the first context comprises modifying the second context.

17. The non-transitory machine readable medium of claim 16, wherein the modifying the second context comprises:
identifying a portion of the second context that includes data that supports the answer; and
removing the portion of the second context from the second context.

18. The non-transitory machine readable medium of claim 17, wherein the modified answer indicates that the question is unanswerable.

19. The non-transitory machine-readable medium of claim 15, wherein the operations further comprise:
generating, by at least one Application-Specific Integrated Circuit (ASIC) performing a multiplicative and/or accumulative operation for the AI agent, a next token; and
generating a natural language output representing an answer to a query based on combining a sequence of generated tokens.

20. The non-transitory machine-readable medium of claim 19, wherein the query is associated with identifying an information technology (IT) anomaly relating to a usage of an IT component, and wherein the operations further comprise:
determining, based on the answer, that an updated action execution state representing an information technology anomaly; and
causing an alert relating to the information technology anomaly to be displayed at a visualized user interface of a user device.
